(19) United States
(12) Patent Application Publication
(10) Pub. No.: US 2025/0330223 A1
(43) Pub. Date: Oct. 23, 2025

(54) METHOD AND APPARATUS FOR ACQUIRING CHANNEL QUALITY, STORAGE MEDIUM AND CHIP

(71) Applicant: Beijing Xiaomi Mobile Software Co., Ltd., Beijing (CN)

(72) Inventors: Liangang CHI, Beijing (CN); Dong CHEN, Beijing (CN)

(21) Appl. No.: 18/866,483

(22) PCT Filed: May 19, 2022
(86) PCT No.: PCT/CN2022/093972

§ 371 Date: Nov. 15, 2024

(51) Int. Cl. H04B 7/06

(52) U.S. Cl. CPC H04B 7/0626; H04B 7/0634

(57) ABSTRACT

A method for acquiring channel quality includes: receiving a pilot signal sent by a network device through a downlink channel; obtaining a first channel matrix according to the pilot signal, wherein the first channel matrix is used to represent channel quality of the downlink channel; obtaining a compressed target channel matrix by compressing the first channel matrix according to a channel state information (CSI) compression model and a CSI compression parameter, wherein the CSI compression model comprises a channel encoder, and the channel encoder comprises a plurality of sub-encoders; and different sub-encoders correspond to different CSI compression parameters; and sending the target channel matrix to the network device, such that the channel quality of the downlink channel is determined by the network device according to the target channel matrix.

### CROSS-REFERENCE TO RELATED APPLICATION

The present application is a U.S. National Phase of International Patent Application Serial No. PCT/CN2022/093972 filed on May 19, 2022. The contents of this application are hereby incorporated by reference in their entirety for all purposes.

### BACKGROUND OF THE INVENTION

As a key technology of the 5th Generation Mobile Communication Technology (5G), massive Multiple-Input Multiple-Output (mMIMO) technology has become widely researched and used in the field of communications in recent years. By deploying a large number of antennas using centralized or distributed methods at a transmitting end, a mMIMO system has shown good performance in system stability, energy utilization, and anti-interference ability.

### SUMMARY OF THE INVENTION

To solve the above problems existing in the related art, the disclosure provides a method and apparatus for acquiring channel quality, a storage medium and a chip.

According to a first aspect of an example of the disclosure, a method for acquiring channel quality is provided, and the method is performed by a terminal device and includes: receiving a pilot signal sent by a network device through a downlink channel; obtaining a first channel matrix according to the pilot signal, where the first channel matrix is used to represent channel quality of the downlink channel; obtaining a compressed target channel matrix by compressing the first channel matrix according to a channel state information (CSI) compression model and a CSI compression parameter, where the CSI compression model includes a channel encoder, and the channel encoder includes a plurality of sub-encoders; and different sub-encoders correspond to different CSI compression parameters; and sending the target channel matrix to the network device, such that the channel quality of the downlink channel is acquired by the network device according to the target channel matrix.

According to a second aspect of an example of the disclosure, a method for acquiring channel quality is provided, and the method is performed by a network device and includes: receiving a target channel matrix sent by a terminal device, where the target channel matrix is obtained after a first channel matrix is compressed by the terminal device according to a channel state information (CSI) compression model and a CSI compression parameter, and the first channel matrix is a matrix obtained by the terminal device according to a pilot signal and used to represent channel quality of a downlink channel; obtaining a third channel matrix by decompressing the target channel matrix according to a channel state information (CSI) decompression model and the CSI compression parameter, where the CSI decompression model includes a channel decoder, the channel decoder includes a plurality of sub-decoders, and different sub-decoders correspond to different CSI compression parameters; and determining the channel quality of the downlink channel according to the third channel matrix.

According to a third aspect of an example of the disclosure, an apparatus for acquiring channel quality is provided, including: one or more processors; and a memory for storing instructions executable by the one or more processors; where the one or more processors are collectively configured to execute steps of the method for acquiring channel quality provided in the first aspect of the disclosure.

According to a fourth aspect of an example of the disclosure, an apparatus for acquiring channel quality is provided, including: one or more processors; and a memory for storing instructions executable by the one or more processors; where the one or more processors are collectively configured to execute steps of the method for acquiring channel quality provided in the second aspect of the disclosure.

According to a fifth aspect of an example of the disclosure, a non-transitory computer-readable storage medium is provided, storing computer program instructions, and the computer program instructions, when executed by one or more processors, implement steps of the method for acquiring channel quality provided in the first aspect of the disclosure.

According to a sixth aspect of an example of the disclosure, a non-transitory computer-readable storage medium is provided, storing computer program instructions, and the computer program instructions, when executed by one or more processors, implement steps of the method for acquiring channel quality provided in the second aspect of the disclosure.

According to a seventh aspect of an example of the disclosure, a chip is provided, including: one or more processors and an interface. The processor is configured to read instructions to execute steps of the method for acquiring channel quality provided in the first aspect of the disclosure.

According to an eighth aspect of an example of the disclosure, a chip is provided, including: one or more processors and an interface. The processor is configured to read instructions to execute steps of the method for acquiring channel quality provided in the second aspect of the disclosure.

It is to be understood that the above general descriptions and later detailed descriptions are merely exemplary and illustrative, and cannot limit the disclosure.

### BRIEF DESCRIPTION OF DRAWINGS

The accompanying drawings here are incorporated into the specification and constitute a part of the specification, show examples consistent with the disclosure, and together with the specification, are used to explain the principle of the disclosure.

FIG. 1 is a block diagram of a communication system shown according to an example.

FIG. 2 is a flow diagram of a method for acquiring channel quality shown according to an example.

FIG. 3 is a flow diagram of a method for acquiring channel quality shown according to an example.

FIG. 4 is a schematic structural diagram of a network model for acquiring channel quality shown according to an example.

FIG. 5 is a schematic diagram of a feature converter in a CSI compression model shown according to an example.

FIG. 6 is a schematic diagram of a channel encoder in a CSI compression model shown according to an example.

FIG. 7 is a schematic diagram of a CSI decompression model shown according to an example.

FIG. 8 is a flow diagram of a method for training a CSI compression model shown according to an example.

FIG. 9 is a flow diagram of a method for training a CSI decompression model shown according to an example.

FIG. 10 is a flow diagram of a method for acquiring channel quality shown according to an example.

FIG. 11 is a block diagram of an apparatus for acquiring channel quality shown according to an example.

FIG. 12 is a block diagram of an apparatus for acquiring channel quality shown according to an example.

FIG. 13 is a block diagram of an apparatus for acquiring channel quality shown according to an example.

FIG. 14 is a block diagram of an apparatus for acquiring channel quality shown according to an example.

FIG. 15 is a block diagram of an apparatus for acquiring channel quality shown according to an example.

FIG. 16 is a block diagram of an apparatus for acquiring channel quality shown according to an example.

### DETAILED DESCRIPTION OF THE INVENTION

Examples will be described in detail here, and instances of the examples are shown in the accompanying drawings. When the following description refers to the accompanying drawings, unless otherwise indicated, the same numbers in different accompanying drawings indicate the same or similar elements. The implementations described in the following examples do not represent all implementations consistent with the disclosure. Rather, they are merely instances of apparatuses and methods consistent with some aspects of the disclosure as detailed in the appended claims.

It is to be noted that all actions to acquire signals, information, or data in the disclosure are carried out in accordance with the corresponding data protection regulations and policies of the country where they are located, and authorized by the corresponding apparatus owner.

In the disclosure, the used terms such as “first” and “second” are used to distinguish similar objects, and need not be understood as a specific order or sequence. In addition, unless otherwise stated, in the description with reference to the accompanying drawings, the same symbol in different accompanying drawings represents the same element.

In descriptions of the disclosure, unless otherwise specified, “plurality of” refers to two or more than two, and other quantifiers are similar to it; and “at least one of the following” or its similar expressions refer to any combination of these items, including any combination of single or multiple items. For example, at least one of a, b, or c may represent: a, b, c, a-b, a-c, b-c, or a-b-c, where a, b, and c may be single or multiple; and “and/or” is a description of the association relationship between associated objects, indicating that there may be three types of relationships, for example, A and/or B may represent: the existence of A alone, the existence of A and B at the same time, and the existence of B alone, where A and B may be singular or plural.

In examples of the disclosure, although operations are described in a specific order in the accompanying drawings, it may not be understood as requiring these operations to be performed in the specific order or serial order shown, or requiring all the operations shown to be performed to achieve the desired results. Multitasking and parallel processing may be advantageous in a particular environment.

The disclosure relates to the technical field of communications, and particularly relates to a method and apparatus for acquiring channel quality, a storage medium and a chip.

In order to fully utilize the advantages of the mMIMO system, accurate channel state information (CSI) needs to be obtained at the transmitting end. For example, a terminal device may report CSI to a network device so that the network device acquires the channel quality of a downlink channel and selects an appropriate modulation and coding scheme for downlink transmission according to the channel quality so as to improve the performance of data transmission. However, in mMIMO, as the number of antennas continues to increase, the information contained in CSI becomes increasingly rich, resulting in higher resource overhead for CSI reporting.

With the application of the mMIMO technology, in order to reduce the overhead of CSI reporting, a CSI compression technique based on discrete Fourier transform (DFT) may be adopted, where a terminal device performs CSI compression before reporting to a network device. However, CSI compression reporting can reduce the accuracy of channel quality acquired by the network device, and the efficiency of data transmission is affected.

For example, the terminal device may compress CSI by using a pre-trained encoding neural network and report compressed CSI to the network device, and the network device also decompresses the compressed CSI by using a decoding neural network so as to determine the channel quality. However, due to different CSI compression rates, the requirements for the encoding neural network and the decoding neural network are different, and their parameters are also different. Thus, in a scenario where the CSI compression rate changes, if the same encoding neural network and decoding neural network are used, significant differences in accuracy of CSI reporting will be caused. When the CSI compression rate changes, if the encoding neural network and the decoding neural network are re-trained, the efficiency will be low, and they will not be able to adapt to scenarios where the CSI compression rate frequently changes.

To solve the above problems, the disclosure provides a method and apparatus for acquiring channel quality, a storage medium and a chip.

Firstly, an implementation environment of examples of the disclosure is introduced below.

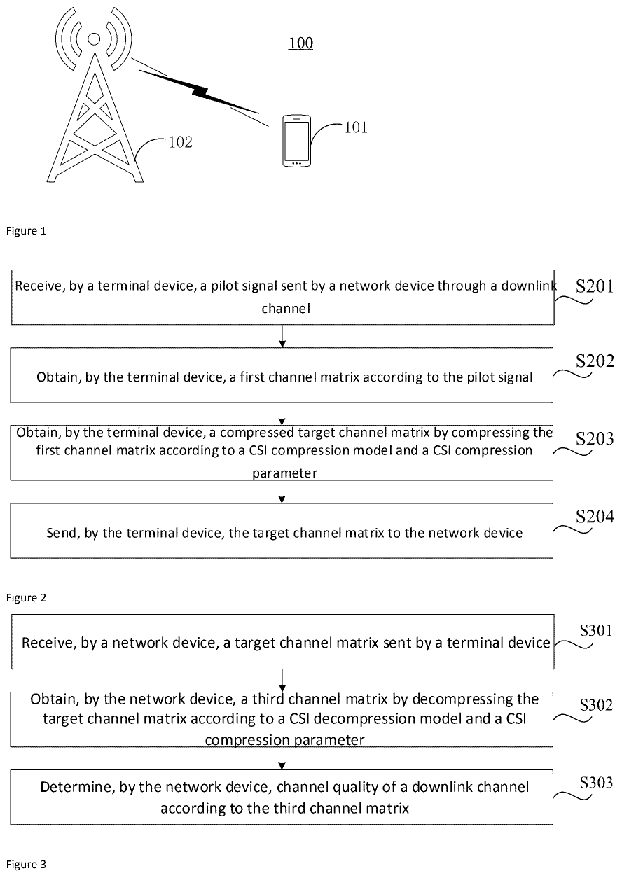

FIG. 1 is a schematic diagram of a communication system shown according to an example. As shown in FIG. 1, the communication system 100 may include a terminal device 101 and a network device 102. The communication system 100 may be configured to support the 4th Generation (4G) network access technology, such as the long term evolution (LTE) access technology, or the 5th Generation (5G) network access technology, such as the new radio access technology (New RAT), or other wireless communication technologies in the future. It is to be noted that, the communication system 100 may be a communication system adopting a frequency division duplexing (FDD) technology, or a communication system adopting a time division duplexing (TDD) technology. In addition, in this communication system 100, the quantity of network devices and the quantity of terminal devices may both be one or more. The quantity of the network device and the terminal device in the communication system 100 shown in FIG. 1 is only an adaptive example, which is not limited in the disclosure.

The network device in FIG. 1 may be configured to support terminal access, for example, it may be an evolutional Node B (eNB or eNodeB) in LTE; or a base station in a 5G network or a future evolved public land mobile network (PLMN), a broadband network gateway (BNG), an aggregation switch, or a non-3GPP (3rd Generation Partnership Project) access device, etc. In one embodiment, the network device in the example of the disclosure may include various forms of base stations, such as macro base stations, micro base stations (also known as small stations), relay stations, access points, 5G base stations or future base stations, satellites, transmitting and receiving points (TRPs), transmitting points (TPs), mobile switching centers, and devices that perform base station functions in device-to-device (D2D), vehicle-to-everything (V2X), and machine-to-machine (M2M) communications, which is not specifically limited in the example of the disclosure. For case of descriptions, in all examples of the disclosure, apparatuses providing a wireless communication function for the terminal device are collectively referred to as a network device or a base station.

The terminal device in FIG. 1 may be an electronic device that provides voice or data connectivity, for example, the terminal device may also be referred to as user equipment (UE), a subscriber unit, a mobile station, a station, a terminal, etc. For example, the terminal device may include a smart phone, a smart wearable device, a smart speaker, a smart tablet, a wireless modem, a wireless local loop (WLL) station, a personal digital assistant (PDA), customer premise equipment (CPE), etc. With the development of the wireless communication technology, devices that can access communication systems, communicate with network devices of communication systems, or communicate with other objects through communication systems can all be terminal devices in the example of the disclosure, such as terminals and automobiles in intelligent transportation, household devices in smart homes, power meter reading instruments in smart grids, voltage monitoring instruments, environmental monitoring instruments, video monitoring instruments in intelligent security networks, and cash registers. In the example of the disclosure, the terminal device may communicate with the network device, such as the network device in FIG. 1. A plurality of terminals may also communicate with one another. The terminals may be statically fixed or mobile, which is not limited in the disclosure.

FIG. 2 is a flow diagram of a method for acquiring channel quality shown according to an example. The method may be performed by a terminal device, and as shown in FIG. 2, the method may include steps from S201 to S204.
S201, a pilot signal sent by a network device through a downlink channel is received by the terminal device.

For example, in the above communication system, the pilot signal may be sent to the terminal device by the network device through the downlink channel. Accordingly, the pilot signal may be received by the terminal device.

In some examples, the pilot signal may include a channel state information reference signal (CSI-RS).
S202, a first channel matrix is obtained by the terminal device according to the pilot signal.

The first channel matrix may be used to represent the channel quality of the downlink channel.

For example, the terminal device may perform a channel state information (CSI) estimation according to the received pilot signal (e.g., the CSI-RS) to obtain a CSI estimation matrix, and then may obtain the first channel matrix representing the quality of the downlink channel according to the CSI estimation matrix.
S203, a compressed target channel matrix is obtained by compressing the first channel matrix by the terminal device according to a CSI compression model and a CSI compression parameter.

The CSI compression model includes a channel encoder, and the channel encoder includes a plurality of sub-encoders; and different sub-encoders correspond to different CSI compression parameters.

In some examples, the terminal device may determine one or more target sub-encoders from the plurality of sub-encoders according to the CSI compression parameter, and obtain the target channel matrix by compressing the first channel matrix through the target sub-encoders.

For example, the CSI compression parameter may represent a CSI compression rate, and a value of the CSI compression rate may be any preset value, such as: 1/2, 1/4, 1/8, 1/16, 1/32 or 1/64, which is not limited in the disclosure.
S204, the target channel matrix is sent to the network device by the terminal device.

By sending the target channel matrix, the channel quality of the downlink channel may be determined by the network device according to the target channel matrix.

By means of the above method, the pilot signal sent by the network device through the downlink channel is received by the terminal device; the first channel matrix is obtained according to the pilot signal; the compressed target channel matrix is obtained by compressing the first channel matrix according to the CSI compression model and the CSI compression parameter; and the target channel matrix is sent to the network device, such that the channel quality of the downlink channel is determined by the network device according to the target channel matrix. The first channel matrix is used to represent the channel quality of the downlink channel. The CSI compression model includes the channel encoder, and the channel encoder includes the plurality of sub-encoders; and different sub-encoders correspond to different CSI compression parameters. The target channel matrix is used to instruct the network device to determine the channel quality of the downlink channel. In this way, different CSI compression parameters may be fitted through the plurality of sub-encoders, and thus a relatively accurate target channel matrix may be adaptively obtained and sent to the network device under a scenario where a CSI compression rate changes, such that the relatively accurate channel quality is obtained by the network device, and then the efficiency of data transmission is improved.

In some examples, the terminal device may obtain the above first channel matrix in the following ways:
first, a space domain channel matrix is obtained by measurement according to the pilot signal.
Second, the space domain channel matrix is transformed into an angle delay domain channel matrix through discrete Fourier transform.
Then, the first channel matrix is determined according to the angle delay domain channel matrix.

For example, the above communication system may adopt the mMIMO technology based on orthogonal frequency division multiplexing (OFDM), the quantity of sub-carriers is Nₛ, the quantity of antennas for mMIMO of the network device may be Nₜ, and the above pilot signal may include the CSI-RS. Taking the communication system as an example, the above steps are illustrated as follows:
first, the terminal device may obtain a space domain channel matrix H by measurement (may also be called estimation) according to a received CSI-RS, the size of the space domain channel matrix H may be Nₛ×Nₜ, and the space domain channel matrix H may represent the channel quality per sub-carrier per antenna.
Second, the terminal device may transform the space domain channel matrix into an angle delay domain channel matrix through discrete Fourier transform. For example, the angle delay domain channel matrix may be obtained through following formula (1):

$${H}_{a} = {F}_{d} {HF}_{a} \qquad ( 1 )$$

where H denotes the space domain channel matrix, the size of H may be Nₛ×Nₜ, Hₐ denotes the transformed angle delay domain channel matrix, F_{d} and Fₐ denote discrete Fourier transform matrices with the sizes of Nₛ×Nₛ and Nₜ×Nₜ, Nₛ denotes the quantity of sub-carriers corresponding to mMIMO, and Nₜ denotes the quantity of antennas corresponding to mMIMO.

Finally, the first channel matrix is determined according to a principal value part of the angle delay domain channel matrix.

It is to be noted that, due to the influence of multipath delay, the angle delay domain channel matrix Hₐ merely has values in first Ne rows, a principal value channel matrix under an angle delay domain is obtained after the principal value part is cut off, and the size of the principal value channel matrix may be N_{c}×Nₜ.

Further, by dividing a real part and an imaginary part of the principal value channel matrix, the first channel matrix H_{c}∈R^{c×N}^{_{c}}^{×N}^{ₜ} may be obtained, where c is a real-imaginary part dimension of the channel, for example, c may be 2, and the target channel matrix may be obtained by using the first channel matrix as an input of the CSI compression model.

In this way, the first channel matrix representing the quality of the downlink channel may be obtained according to the pilot signal through the above manners.

The above CSI compression parameter may be a parameter received from the network device by the terminal device, or a parameter preset by the terminal device.

In some examples, the CSI compression parameter may be determined by the terminal device according to a parameter received from the network device. For example, the terminal device may receive a first compression parameter sent by the network device; and determine the CSI compression parameter according to the first compression parameter. For instance, the terminal device may receive the first compression parameter through radio resource control (RRC) signaling (e.g., broadcast signaling, or, signaling dedicated for the terminal device).

In some examples, the network device may preset a value of the CSI compression parameter, determine the first compression parameter according to the CSI compression parameter, and send the first compression parameter to the terminal device.

For example, the CSI compression parameter and the first compression parameter may be determined through a preset correspondence relationship for the first compression parameter. For instance, in a case that the CSI compression parameter represents a CSI compression rate, a first compression parameter corresponding to a value 1/2 of the CSI compression parameter may be 1, a first compression parameter corresponding to a value 1/4 of the CSI compression parameter may be 2, a first compression parameter corresponding to a value 1/8 of the CSI compression parameter may be 3, and so on for other values.

In this way, after receiving the first compression parameter sent by the network device, the terminal device may determine the CSI compression parameter according to the first compression parameter.

In some examples, the network device may update the value of the CSI compression parameter and determine a new first compression parameter according to the updated CSI compression parameter. Similarly, the terminal device may also determine a new CSI compression parameter according to the new first compression parameter in a case of receiving the new first compression parameter.

In other examples, the value of the CSI compression parameter may be preset by the terminal device, for instance, the value of the CSI compression parameter may be a preset parameter value of the terminal device or a parameter value set by the terminal device according to a user input.

In some examples, the terminal device may determine a second compression parameter according to a preset value of the CSI compression parameter, and send the second compression parameter to the network device, such that the same CSI compression parameter is used after consensus. For instance, the terminal device may send the second compression parameter to the network device through RRC signaling.

Similarly, the CSI compression parameter and the second compression parameter may be determined through a preset correspondence relationship for the second compression parameter.

In some examples, the terminal device may determine a value of the CSI compression parameter according to own device parameters, which may include one or more of the following: a protocol version of the terminal device, signal quality of the terminal device, a distance between the terminal device and the network device, the amount of uplink data of the terminal device, and the amount of downlink data of the terminal device. The signal quality of the terminal device may include reference signal receiving power (RSRP) or a signal to interference plus noise ratio (SINR).

In some examples, the terminal device may update the value of the CSI compression parameter and determine a new second compression parameter according to the updated CSI compression parameter. For instance, the terminal device may update the value of the CSI compression parameter according to changed new device parameters in a case of determining that the above device parameters change. Similarly, the network device may also determine a new CSI compression parameter according to the new second compression parameter in a case of receiving the new second compression parameter.

In other examples, the CSI compression parameter may include third compression parameters which are preset in the terminal device and the network device respectively, and the third compression parameters preset in the terminal device and the network device may have the same value.

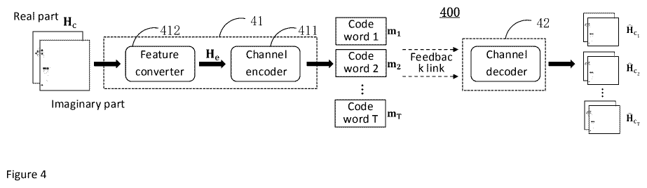

FIG. 3 is a flow diagram of a method for acquiring channel quality shown according to an example. The method may be performed by a network device, and as shown in FIG. 3, the method may include steps from S301 to S303.
S301, a target channel matrix sent by a terminal device is received by the network device.

The target channel matrix is obtained after a first channel matrix is compressed by the terminal device according to a channel state information (CSI) compression model and a CSI compression parameter, and the first channel matrix is a matrix obtained by the terminal device according to a pilot signal and used to represent channel quality of a downlink channel.

In some examples, the network device may send the pilot signal through the downlink channel, such that the terminal device receives the pilot signal and obtains the first channel matrix. For example, the pilot signal may include a channel state information reference signal (CSI-RS).
S302, a third channel matrix is obtained by decompressing the target channel matrix by the network device according to a CSI decompression model and the CSI compression parameter.

The CSI decompression model may include a channel decoder, the channel decoder includes a plurality of sub-decoders, and different sub-decoders correspond to different CSI compression parameters.

In some examples, the network device may determine one or more target sub-decoders from the plurality of sub-decoders according to the CSI compression parameter, and obtain the target channel matrix by compressing the first channel matrix through the target sub-decoders.

For example, the CSI compression parameter may represent a CSI compression rate, and a value of the CSI compression rate may be any preset value, such as: 1/2, 1/4, 1/8, 1/16, 1/32 or 1/64, which is not limited in the disclosure.
S303, the channel quality of the downlink channel is determined by the network device according to the third channel matrix.

By means of the above method, the target channel matrix sent by the terminal device is received; the third channel matrix is obtained by decompressing the target channel matrix according to the CSI decompression model and the CSI compression parameter; and the channel quality of the downlink channel is determined according to the third channel matrix. The target channel matrix is obtained after the first channel matrix is compressed by the terminal device according to the CSI compression model and the CSI compression parameter, and the first channel matrix is a matrix obtained by the terminal device according to the pilot signal and used to represent the channel quality of the downlink channel. The CSI decompression model may include the channel decoder, the channel decoder includes the plurality of sub-decoders, and different sub-decoders correspond to different CSI compression parameters. In this way, different CSI compression parameters may be fitted by the network device through the plurality of sub-decoders, and thus a relatively accurate third channel matrix may be adaptively obtained under a scenario where a CSI compression rate changes, the relatively accurate channel quality is obtained according to the third channel matrix, the network device may determine a modulation and coding scheme corresponding to the downlink channel according to the channel quality, and then the efficiency of data transmission is improved.

In some examples, the network device may use a sub-decoder corresponding to the CSI compression parameter as a target sub-decoder; obtain a fourth channel matrix by decompressing the target channel matrix through the target sub-decoder; and determine the third channel matrix according to the fourth channel matrix.

For example, the sub-decoder may include a decompression layer which may correspond to a compression layer of a sub-encoder in a channel encoder of the terminal device.

In some examples, the CSI decompression model may further include a CSI reconstruction module, and the network device may input the above fourth channel matrix into the CSI reconstruction module to obtain the third channel matrix.

For example, the CSI reconstruction module may include a convolutional neural network (CNN).

In some examples, a value of the CSI compression parameter may be preset by the network device, for instance, the value of the CSI compression parameter may be a preset parameter value of the network device or a parameter value set by the network device according to a user input.

In some examples, the network device may determine a first compression parameter according to the CSI compression parameter and send the first compression parameter to the terminal device so as to instruct the terminal device to determine the CSI compression parameter according to the first compression parameter. For instance, the network device may send the first compression parameter through radio resource control (RRC) signaling (e.g., broadcast signaling, or, signaling dedicated for the terminal device).

For example, the CSI compression parameter and the first compression parameter may be determined through a preset correspondence relationship for the first compression parameter. For instance, in a case that the CSI compression parameter represents a CSI compression rate, a first compression parameter corresponding to a value 1/2 of the CSI compression parameter may be 1, a first compression parameter corresponding to a value 1/4 of the CSI compression parameter may be 2, a first compression parameter corresponding to a value 1/8 of the CSI compression parameter may be 3, and so on for other values. In this way, after receiving the first compression parameter sent by the network device, the terminal device may determine the CSI compression parameter according to the first compression parameter.

In some examples, different values of the CSI compression parameter may be set by the network device for different terminal devices. For example, the value of the CSI compression parameter may be determined according to device parameters corresponding to the terminal device, and the device parameters may include one or more of the following: a protocol version of the terminal device, signal quality of the terminal device, a distance between the terminal device and the network device, the amount of uplink data of the terminal device, and the amount of downlink data of the terminal device. The signal quality of the terminal device may include reference signal receiving power (RSRP) or a signal to interference plus noise ratio (SINR).

In other examples, the network device may update the value of the CSI compression parameter and determine a new first compression parameter according to the updated CSI compression parameter. For instance, the network device may obtain the device parameters corresponding to the terminal device, and may update the value of the CSI compression parameter in a case of determining that the device parameters change.

Similarly, the terminal device may also determine a new CSI compression parameter according to the new first compression parameter in a case of receiving the new first compression parameter.

In other examples, the CSI compression parameter may be determined by the network device according to a parameter received from the terminal device. For example, the network device may receive a second compression parameter sent by the terminal device; and determine the CSI compression parameter according to the second compression parameter. For instance, the network device may receive the second compression parameter through RRC signaling.

For example, the terminal device may preset the value of the CSI compression parameter, determine the second compression parameter according to the CSI compression parameter, and send the second compression parameter to the network device. Similarly, the CSI compression parameter and the second compression parameter may be determined through a preset correspondence relationship for the second compression parameter. In this way, after receiving the second compression parameter sent by the terminal device, the network device may determine the CSI compression parameter according to the second compression parameter.

In some examples, the terminal device may update the value of the CSI compression parameter and determine a new second compression parameter according to the updated CSI compression parameter. Similarly, the network device may also determine a new CSI compression parameter according to the new second compression parameter in a case of receiving the new second compression parameter.

In other examples, the CSI compression parameter may also include third compression parameters which are preset in the terminal device and the network device respectively, and the third compression parameters preset in the terminal device and the network device may have the same value.

In some examples, the above CSI compression model and CSI decompression model may jointly compose a network model for acquiring the channel quality. The network model for acquiring the channel quality is detailed below in combination with the accompanying drawings.

FIG. 4 is a schematic structural diagram of the network model for acquiring the channel quality shown according to an example.

As shown in FIG. 4, in some examples, the network model 400 for acquiring the channel quality may include a channel state information (CSI) compression model 41 and a CSI decompression model 42. The CSI compression model 41 may be deployed on the terminal device in the communication system shown in FIG. 1, for example, the terminal device may run the CSI compression model 41 through software, hardware or a combination of software and hardware. The CSI decompression model 42 may be deployed on the network device (e.g., base station) in the communication system shown in FIG. 1, for example, the network device may run the CSI decompression model 42 through software, hardware or a combination of software and hardware.

The CSI compression model 41 may compress an input first channel matrix according to a CSI compression parameter and then output a target channel matrix (the target channel matrix may also be called a codeword). The terminal device may send the target channel matrix to the network device, and correspondingly, the network device may input the received target channel matrix into the CSI decompression model 42. The CSI decompression model 42 may decode (or decompress) the target channel matrix according to the CSI compression parameter and output a third channel matrix, and the network device may determine the channel quality of a downlink channel according to the third channel matrix.

As shown in FIG. 4, in some examples, the CSI compression model 41 may include a channel encoder 411, and the channel encoder 411 may encode the input channel matrix according to the CSI compression parameter to obtain the target channel matrix.

Further, the channel encoder 411 may include a plurality of sub-encoders, and different sub-encoders correspond to different CSI compression parameters. In this way, the terminal device may use a sub-encoder corresponding to the CSI compression parameter as a first target sub-encoder, and obtain the target channel matrix by compressing the first channel matrix through the first target sub-encoder. The target channel matrix may also be called a codeword.

For example, in a case that the CSI compression parameter includes a CSI compression rate, the channel encoder 411 may include a sub-encoder 1 (a corresponding CSI compression parameter is 1/2), a sub-encoder 2 (a corresponding CSI compression parameter is 1/4), a sub-encoder 3 (a corresponding CSI compression parameter is 1/8), a sub-encoder 4 (a corresponding CSI compression parameter is 1/16), a sub-encoder 5 (a corresponding CSI compression parameter is 1/32), a sub-encoder 6 (a corresponding CSI compression parameter is 1/64), etc.

As shown in FIG. 4, in other examples, the CSI compression model may include the channel encoder 411 and a feature converter (which may also be called a feature optimizer or feature combining optimizer) 412. An input of the feature converter 412 may be the above first channel matrix, the feature converter 412 is used to perform key feature extraction on the first channel matrix to obtain a second channel matrix representing a CSI key feature, the second channel matrix may be used as an input of the channel encoder 411, and the channel encoder 411 may compress the second channel matrix according to the CSI compression parameter to obtain the target channel matrix. For example, the terminal device may use a sub-encoder corresponding to the CSI compression parameter as a second target sub-encoder, and then obtain the target channel matrix by compressing the second channel matrix through the second target sub-encoder. The target channel matrix may also be called a codeword.

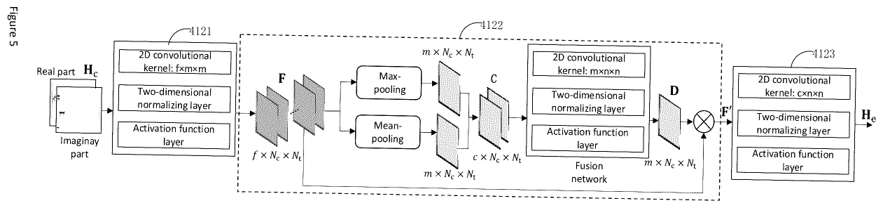

FIG. 5 is a schematic diagram of a feature converter in a CSI compression model shown according to an example. As shown in FIG. 5, the feature converter 412 includes a feature extraction network 4121, an attention mechanism network 4122 and a feature restoration network 4123.

In some examples, a terminal device may input a first channel matrix into the feature converter, and obtain a second channel matrix representing a CSI key feature by performing key feature extraction on the first channel matrix.

For example, the second channel matrix may be obtained through the following steps:
S51, a plurality of first feature maps are obtained by inputting the first channel matrix into the feature extraction network.

For example, the feature extraction network converts the first channel matrix H_{c} into first feature maps F∈R^{f×N}^{_{c}}^{×N}^{ₜ}, where f denotes the quantity of the first feature maps extracted. f may be any positive integer greater than 1.

In some examples, the feature extraction network may include a two-dimensional convolutional layer, a size of a convolutional kernel may be f×m×m, where f denotes the quantity of the first feature maps, and m×m denotes a length and a width of a convolutional window used by the convolutional kernel. The feature extraction network may normalize an output of the convolutional layer using a two-dimensional normalizing layer, and an activation function of the feature extraction network may include Sigmoid, ReLU, LeakyReLU, PRELU or ELU.

For example, the activation function may use the Leaky ReLU (leaky rectified linear unit) activation function, which may include following formula (2):

$$Leaky ReLU ( x ) = \{ \begin{matrix}x , & x \geq 0 \\ γ x , & x \leq 0\end{matrix} \qquad ( 2 )$$

where x denotes an input vector, such as an input first feature map; y denotes a preset coefficient, for example, the preset coefficient may be any numeric value smaller than 1, and for instance, the preset coefficient may be 0.3; and LeakyReLU(x) denotes an output value of the Leaky ReLU activation function.
S52, a second feature map is obtained by inputting the plurality of first feature maps into the attention mechanism network.

The second feature map may include key feature information in the first feature maps.

In some examples, a max-pooling feature map may be obtained by performing a max-pooling operation on the plurality of first feature maps through the attention mechanism network; a mean-pooling feature map is obtained by performing a mean-pooling operation on the plurality of first feature maps through the attention mechanism network; and then the second feature map is determined according to the max-pooling feature map and the mean-pooling feature map.

It is to be noted that, as for the plurality of first feature maps extracted by the feature extraction network, feature information contained in some of the first feature maps is greatly helpful for CSI reconstruction, and such first feature maps may be referred to as “key feature maps”. Feature information contained in some of the first feature maps almost has no impact on CSI reconstruction, and such first feature maps may be referred to as “unnecessary feature maps”. The attention mechanism network may extract the key feature maps from the plurality of feature maps, such that codewords produced by subsequent encoders contain more key features. For example:
the max-pooling feature map M∈R^{m×N}^{_{c}}^{×N}^{ₜ} may be obtained by performing the max-pooling operation on the first feature maps F through the attention mechanism network. For instance, the max-pooling operation may be performed through following formula (3):

$${m}_{i} = max \{ {F}_{1 , i} , {F}_{2 , i} , {F}_{3 , i} , … , {F}_{f , i} \} , i = \{ 1 , 2 , … , {N}_{c} {N}_{t} \} \qquad ( 3 )$$

where mᵢ denotes the i^{th} element in the max-pooling feature map M, f denotes the quantity of the first feature maps, F_{1,i} denotes the i^{th} element in the 1^{st} first feature map, F_{2,i} denotes the i^{th} element in the 2^{nd} first feature map, F_{3,i} denotes the i^{th} element in the 3^{nd} first feature map, F_{f,i} denotes the i^{th} element in the f^{th} first feature map, and N_{c}×Nₜ denotes the size of the first channel matrix.

In this way, each element in the max-pooling feature map M is composed of the maximum elements at corresponding positions in the plurality of first feature maps.

The mean-pooling feature map V∈R^{m×N}^{_{c}}^{×N}^{ₜ} may further be obtained by performing the mean-pooling operation on the first feature maps F through the attention mechanism network. For instance, the mean-pooling operation may be performed through following formula (4):

$${v}_{i} = \frac{1}{f} ( {F}_{1 , i} + {F}_{2 , i} + {F}_{3 , i} + {F}_{3 , i} , … , {F}_{f - 1 , i} + {F}_{f , i} ) , i = \{ 1 , 2 , … , {N}_{c} {N}_{t} \} \qquad ( 4 )$$

where vᵢ denotes the i^{th} element in the mean-pooling feature map V, f denotes the quantity of the first feature maps, F_{1,i} denotes the i^{th} element in the 1st first feature map, F_{2,i} denotes the i^{th} element in the 2nd first feature map, F_{3,i} denotes the i^{th} element in the 3^{nd} first feature map, F_{f-1,i} denotes the i^{th} element in the (f−1)^{th} first feature map, Fri denotes the i^{th} element in the f^{th} first feature map, and N_{c}×Nₜ denotes the size of the first channel matrix.

In this way, each element in the mean-pooling feature map V is composed of mean values of all elements at corresponding positions in the plurality of first feature maps.

Further, the second feature map may be determined according to the max-pooling feature map and the mean-pooling feature map.

In some examples, a fused fusion feature map may be obtained by inputting the max-pooling feature map and the mean-pooling feature map into a fusion sub-network; and the second feature map is obtained by calculation according to the fusion feature map and the first feature maps.

In some examples, the max-pooling feature map M and the mean-pooling feature map V may be spliced to obtain a combined feature map C∈R^{c×N}^{_{c}}^{×N}^{ₜ}, and the fusion feature map D∈R^{m×N}^{_{c}}^{×N}^{ₜ} is obtained from the combined feature map C through a fusion network.

In some examples, the fusion network may adopt a two-dimensional convolutional layer, the size of a convolutional kernel is m×n×n, the fusion network may further include a two-dimensional normalizing layer and an activation function, and the activation function may include a Sigmoid activation function.

Afterwards, the fusion feature map D is multiplied by a first feature matrix F, the second feature map F′∈R^{f×N}^{_{c}}^{×N}^{ₜ} may be obtained, and the second feature map F′ may also be referred to as an optimization feature map.

In this way, the feature information in the key feature maps is highlighted in the second feature map F′, while the feature information in the unnecessary feature maps is weakened, and thus the CSI key feature may be represented.
S53, the second channel matrix is obtained by inputting the second feature map into the feature restoration network.

For example, the second feature map F′ may be restored to the second channel matrix Hₑ∈R^{c×N}^{_{c}}^{×N}^{ₜ} through the feature restoration network.

In some examples, the feature restoration network may include a two-dimensional convolutional layer, a two-dimensional normalizing layer and an activation function, and the activation function may be a LeakyReLU activation function or other activation functions in the related art, which is not limited in the disclosure.

In some examples, the feature restoration network and the feature extraction network may adopt the same activation function to avoid feature distortion.

Thus, the key feature information is highlighted in the second channel matrix Hₑ obtained in this way, and unnecessary feature information is weakened, so that the CSI key feature may be represented.

FIG. 6 is a schematic diagram of a channel encoder in a CSI compression model shown according to an example. As shown in FIG. 6, the channel encoder 411 may include a plurality of sub-encoders, such as a sub-encoder 1, a sub-encoder 2, . . . , a sub-encoder T−1, and a sub-encoder T in the figure. T is the quantity of the sub-encoders.

In some examples, the channel encoder may pre-process an input second channel matrix Hₑ first, for instance, dimension transformation may be performed, and a size of the dimension of the transformed second channel matrix may be Hₑ∈R^{2N}^{_{c}}^{N}^{ₜ}. The dimension-transformed second channel matrix is input into the above sub-encoders so as to be processed.

In some examples, a CSI compression parameter may include a plurality of preset CSI compression rates, a collection of the preset CSI compression rates may include σ={σ₁, σ₂, . . . , σ_{T}}, and the preset CSI compression rates in the collection are arranged in a descending order from large to small. As for each compression rate σⱼ, j={1, 2, . . . , T} in the collection, a sub-encoder corresponding to the preset CSI compression rate exists in the channel encoder, for example, the quantity of the sub-encoders is the same as the quantity of the preset CSI compression rates.

For example, the preset CSI compression rate σ₁ corresponding to the sub-encoder 1 may be 1/2, the preset CSI compression rate σ₂ corresponding to the sub-encoder 2 may be 1/4, the preset CSI compression rate σ₃ corresponding to the sub-encoder 3 may be 1/8, the preset CSI compression rate σ₄ corresponding to the sub-encoder 4 may be 1/16, the preset CSI compression rate σ₅ corresponding to the sub-encoder 5 may be 1/32, the preset CSI compression rate σ₆ corresponding to the sub-encoder 6 may be 1/64, and so on. It is to be noted that, the values of the preset CSI compression rates here are all examples, and specific values are not limited in the disclosure.

In some examples, the collection of the preset CSI compression rates may include σ={1/4, 1/16, 1/32, 1/64}, for example, the quantity of the sub-encoders is T=4, and the preset CSI compression rates in the collection are arranged in a descending order. As for each preset CSI compression rate in the collection, a corresponding sub-encoder matching with it exists in the adaptive encoder, for example, the quantity of the sub-encoders is the same as the quantity of dynamic compression rates. For instance, the preset CSI compression rate σ₁ corresponding to the sub-encoder 1 may be 1/4, the preset CSI compression rate σ₂ corresponding to the sub-encoder 2 may be 1/16, the preset CSI compression rate σ₃ corresponding to the sub-encoder 3 may be 1/32, and the preset CSI compression rate σ₄ corresponding to the sub-encoder 4 may be 1/64.

In some examples, each sub-encoder may include a compression layer which may include a full-connection layer. The size of the compression layer of each sub-encoder may be determined according to the CSI compression parameter (e.g., the preset CSI compression rates) and the size of a first channel matrix, for instance, the size of the first channel matrix is c×N_{c}×Nₜ, the preset CSI compression rate is σ₁, and then the size of the compression layer of the sub-encoder corresponding to σ₁ is (c×N_{c}×Nₜ)×d₁, where d₁ may be c×N_{c}×Nₜ×σ₁.

For instance, the size of the first channel matrix is 2×32×32, the preset CSI compression rate is 1/4, and then the size of the compression layer of the sub-encoder corresponding to the preset CSI compression rate may be 2048×512.

In other examples, each sub-encoder may include a compression layer and an encoding switch, in this way, during actual use, a target sub-encoder (e.g., the first target sub-encoder or the second target sub-encoder in the above example) corresponding to the CSI compression parameter (e.g., the CSI compression rates) may be determined, the encoding switch of the target sub-encoder is turned on, the switches of other sub-encoders are turned off, and thus the input second channel matrix may be compressed using the compression layer of the target sub-encoder, and a to-be-determined channel matrix of the target sub-encoder is output and may be used as a target channel matrix M.

In some examples, the preset CSI compression rate with the maximum value is used as a maximum CSI compression rate, the compression layer of the sub-encoder (e.g., the sub-encoder 1 in FIG. 5) corresponding to the maximum CSI compression rate is used as a maximum compression layer, an output of the maximum compression layer may be used as inputs of the compression layers of other sub-encoders, and thus, the efficiency of a compression operation may be improved.

For example, the preset CSI compression rate σ₁ is the maximum compression rate, and the size of the compression layer 1 of the sub-encoder 1 corresponding to σ₁ may be (c×N_{c}×Nₜ)×d₁, where d₁ may be c×N_{c}×Nₜ×σ₁. An output of the compression layer 1 may be used as inputs of the compression layers corresponding to other sub-encoders, the sizes of the compression layers corresponding to other sub-encoders may be d₁×dₖ, and dₖ may be c×N_{c}×Nₜ×σₖ. k denotes serial numbers of the sub-encoders, σₖ denotes the preset CSI compression rate corresponding to the kth sub-encoder, and c×N_{c}×Nₜ denotes the size of the first channel matrix.

For instance, the size of the first channel matrix is 2×32×32, the maximum compression rate σ₁ is 1/2, and then the size of the compression layer 1 of the sub-encoder 1 corresponding to σ₁ may be 2048×1024; the preset CSI compression rate σ₂ corresponding to the sub-encoder 2 is 1/4, and then the size of the compression layer 2 of the sub-encoder 2 may be 1024×512; and the preset CSI compression rate σ₃ corresponding to the sub-encoder 3 is 1/16, and then the size of the compression layer 3 of the sub-encoder 3 may be 1024×256.

In this way, the compression layers in the sub-encoder 2 to the sub-encoder T in FIG. 6 may play a role in further dimensionality reduction.

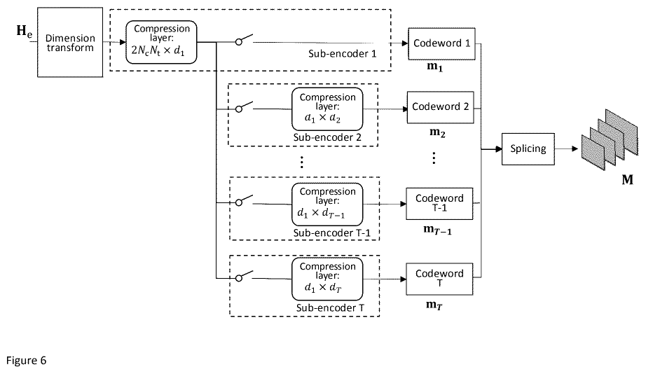

FIG. 7 is a schematic diagram of a CSI decompression model shown according to an example. As shown in FIG. 7, the CSI decompression model 42 may include a channel decoder 421.

In some examples, the channel decoder 421 may have a plurality of sub-decoders, and different sub-decoders correspond to different CSI compression parameters. Each sub-decoder may decompress a received target channel matrix through a decompression layer to obtain a third channel matrix. The decompression layer may include a full-connection layer.

As shown in FIG. 7, the channel decoder 421 may include a plurality of sub-decoders, such as a sub-decoder 1, a sub-decoder 2, . . . , a sub-decoder T−1, and a sub-decoder T. T is the quantity of the sub-decoders.

In some examples, a CSI compression parameter may include a plurality of preset CSI compression rates, a collection of the preset CSI compression rates may include σ={σ₁, σ₂, . . . , σ_{T}}, and the preset CSI compression rates in the collection are arranged in a descending order from large to small. As for each compression rate σⱼ, j={1, 2, . . . , T} in the collection, a sub-decoder corresponding to the preset CSI compression rate exists in the channel decoder, for example, the quantity of the sub-decoders is the same as the quantity of the preset CSI compression rates.

For example, the preset CSI compression rate σ₁ corresponding to the sub-decoder 1 may be 1/2, the preset CSI compression rate σ₂ corresponding to the sub-decoder 2 may be 1/4, the preset CSI compression rate σ₃ corresponding to the sub-decoder 3 may be 1/8, the preset CSI compression rate σ₄ corresponding to the sub-decoder 4 may be 1/16, the preset CSI compression rate σ₅ corresponding to the sub-decoder 5 may be 1/32, the preset CSI compression rate σ₆ corresponding to the sub-decoder 6 may be 1/64, and so on. It is to be noted that, the values of the preset CSI compression rates here are all examples, and specific values are not limited in the disclosure.

In some examples, each sub-decoder may include a decompression layer and a decoding switch, in this way, during actual use, a target sub-decoder corresponding to the CSI compression parameter (e.g., the CSI compression rates) may be determined, the decoding switch of the target sub-decoder is turned on, the switches of other sub-decoders are turned off, and thus the input target channel matrix may be decompressed using the decompression layer of the target sub-decoder, and a to-be-determined channel matrix corresponding to the target sub-decoder is output and may be used as a fourth channel matrix; and the third channel matrix is determined further according to the fourth channel matrix.

In some examples, the CSI decompression model may further include a CSI reconstruction module 422. The CSI reconstruction module may include convolutional neural networks (CNNs), for example, the CSI reconstruction module includes two CNNs, each CNN includes 5 convolutional layers, and sizes of convolutional kernels of each convolutional layer are c×k×k, f₁×l×l, f₂×l×l, f₂×n×n, and c×m×m (f₁, f₂, k, l, m, n are all preset values, and different values may be preset according to different convolutional layers) in sequence. A step length of each convolutional layer is t, and all the convolutional layers may adopt a normalizing layer and a LeakyReLU activation function. Then, an output element value of a second CNN module is mapped to an interval of [0,1] through a Sigmoid activation function layer. In this way, the CSI reconstruction module may output the third channel matrix Ĥ_{c} corresponding to the target channel matrix.

It is to be noted that, the CSI reconstruction module may output different third channel matrices against different CSI compression parameters (e.g., CSI compression rates). For example, the collection of the preset CSI compression rates in the CSI compression parameter may include σ={σ₁, σ₂, . . . , σ_{T}}, and then the third channel matrices output correspondingly may be Ĥ_{c}_{₁}, Ĥ_{c}_{₂}, . . . , Ĥ_{c}_{_{T}} respectively.

In this way, through the CSI decompression model, a network device may obtain the third channel matrix by decompressing the received target channel matrix, such that the channel quality of a downlink channel is determined according to the third channel matrix.

In some examples, the above CSI compression model and CSI decompression model may be obtained through off-line training, for instance, the above CSI compression model and CSI decompression model may be trained jointly to obtain parameters of the CSI compression model and the CSI decompression model, so that the CSI compression model and the CSI decompression model can match.

The training of the above models may be carried out on a terminal device or a network device, and is explained respectively below in combination with the accompanying drawings.

FIG. 8 is a flow diagram of a method for training a CSI compression model shown according to an example. The training method may be performed by a terminal device. As shown in FIG. 8, the training method may include steps S801 and S802.
S801, a first sample channel matrix for training is obtained by the terminal device.

The first sample channel matrix is a matrix obtained by the terminal device according to a received pilot signal and used to represent the quality of a downlink channel.

In some examples, in an FDD downlink mMIMO system, Nₜ=32 antennas may be configured at half-wavelength intervals in a uniform linear array (ULA) mode on a network device (e.g., base station) side, and a single antenna may be configured on the terminal device. By using a COST2100 channel model, 150,000 space domain CSI matrix samples are produced under a 5.3 GHz indoor micro-cellular scenario, and a training set containing 100,000 samples, a validation set containing 30,000 samples and a testing set containing 20,000 samples are obtained. The training set may be used as the above first sample channel matrix.
S802, the CSI compression model is obtained by the terminal device by training a first target network model according to the first sample channel matrix.

The first target network model includes a first target compression model and a first target decompression model, a network structure of the first target compression model is the same as a network structure of the CSI compression model, for instance, both the first target compression model and the CSI compression model may include a channel encoder, the channel encoder includes a plurality of sub-encoders, and different sub-encoders correspond to different CSI compression parameters; and the first target decompression model includes a channel decoder, the channel decoder includes a plurality of sub-decoders, and different sub-decoders correspond to different CSI compression parameters.

In some examples, a model structure of the above first target compression model may be the same as that of the CSI compression model as shown in FIG. 4, for example, the first target compression model may include a channel encoder and a feature converter, the structure of the feature converter may be as shown in FIG. 5, and the structure of the channel encoder may be as shown in FIG. 6. A model structure of the above first target decompression model may be the same as that of the CSI decompression model as shown in FIG. 7, and the above model structures are not repeated here.

In some examples, a first model training step may be recurrently performed until it is determined according to the first sample channel matrix and a first prediction channel matrix that a trained first target network model meets a first preset iteration stopping condition, and the first target compression model in the trained first target network model is used as the CSI compression model.

The first prediction channel matrix is a matrix output after the first sample channel matrix is input into the first target network model.

For example, a first compression model parameter corresponding to the first target compression model may be used as a model parameter of the CSI compression model.

The first model training step may include:
S81, the first sample channel matrix is input into the first target compression model, and a first target sample channel matrix is obtained after the first sample channel matrix is compressed through the plurality of sub-encoders.
S82, the first target sample channel matrix is input into the first target decompression model, and the first prediction channel matrix is obtained after the first sample channel matrix is decompressed through the plurality of sub-decoders.
S83, in a case that it is determined according to the first sample channel matrix and the first prediction channel matrix that the first target network model does not meet the first preset iteration stopping condition, a first loss value is determined according to the first sample channel matrix and the first prediction channel matrix, the trained first target network model is obtained by updating parameters of the first target network model according to the first loss value, and the trained first target network model is used as a new first target network model.

It is to be noted that, the above first preset iteration stopping condition may be determined according to a loss function used in the training process.

In some examples, encoding switches corresponding to all the sub-encoders may be turned on, decoding switches corresponding to all the sub-decoders are also turned on, training errors under a plurality of CSI compression parameters may be jointly optimized, and the loss function used in the training process may include following formula (5):

$$Loss = \frac{1}{T} ( {loss}_{{σ}_{1}} + {loss}_{{σ}_{2}} + … + {loss}_{{σ}_{T}} ) \qquad ( 5 )$$

where σ₁ denotes a first preset CSI compression rate, σ₂ denotes a second preset CSI compression rate, σ_{T} denotes a T^{th} preset CSI compression rate, T denotes the quantity of preset CSI compression rates in the CSI compression parameter (also the quantity of the sub-encoders, or, the quantity of the sub-decoders), loss_{σ}_{ᵢ} denotes a loss value corresponding to the preset CSI compression rate σ₁, and Loss denotes the first loss value of the above first sample channel matrix and first prediction channel matrix.

In this way, by means of joint optimization of the training errors corresponding to the plurality of CSI compression parameters (e.g., the preset CSI compression rates), a network may optimize the training errors corresponding to all the preset CSI compression rates during one training, and thus the adaptive capacity of the network for the dynamic change of the CSI compression rates is improved. After training is finished, the parameter of the CSI compression model may be obtained.

In some examples, by means of the above training process, parameters resulted after training of the first target decompression model may further be obtained by the terminal device, and the parameters resulted after training of the first target decompression model may be used as parameters of the CSI decompression model at the network device side.

In some examples, after determining the model parameters through the training method, the terminal device may obtain a first decompression model parameter corresponding to the first target decompression model in the trained first target network model; and the first decompression model parameter is sent to the network device so as to instruct the network device to determine the CSI decompression model according to the first decompression model parameter. The CSI decompression model is used for the network device to determine the channel quality of the downlink channel according to a target channel matrix.

For example, the terminal device may send the first decompression model parameter to the network device through signaling or a data message.

In other examples of the disclosure, the above training method may be performed on the network device, and the terminal device may receive a second compression model parameter sent by the network device; and the CSI compression model is determined according to the second compression model parameter.

For instance, the second compression model parameter may be used as the model parameter of the CSI compression model.

For example, the terminal device may receive the second compression model parameter sent by the network device through signaling or a data message, and determine the parameter corresponding to the CSI compression model according to the second compression model parameter.

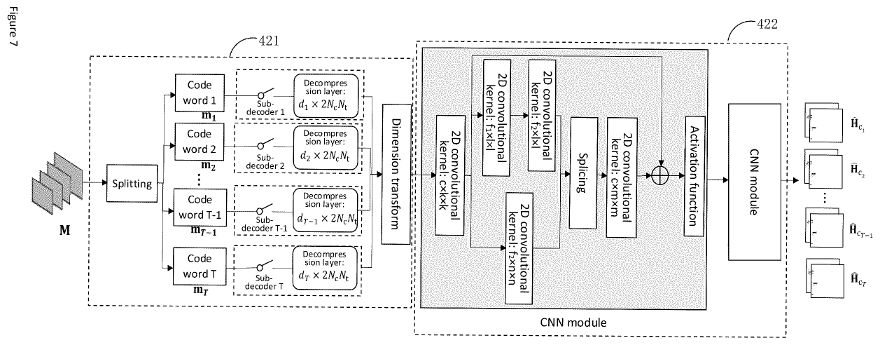

FIG. 9 is a flow diagram of a method for training a CSI decompression model shown according to an example. The training method may be performed by a network device. As shown in FIG. 9, the training method may include steps S901 and S902.
S901, a second sample channel matrix for training is obtained by the network device.

The second sample channel matrix may be a matrix obtained by a terminal device according to a received pilot signal and used to represent the quality of a downlink channel.

In some examples, in an FDD downlink mMIMO system, Nₜ=32 antennas may be configured at half-wavelength intervals in a ULA mode on the network device (e.g., base station) side, and a single antenna may be configured on the terminal device. By using a COST2100 channel model, 150,000 space domain CSI matrix samples are produced under a 5.3 GHZ indoor micro-cellular scenario, and a training set containing 100,000 samples, a validation set containing 30,000 samples and a testing set containing 20,000 samples are obtained. The training set may be used as the second sample channel matrix.
S902, the CSI decompression model is obtained by the network device by training a second target network model according to the second sample channel matrix.

The second target network model includes a second target compression model and a second target decompression model, a network structure of the second target decompression model is the same as a network structure of the CSI decompression model, for instance, both the second target decompression model and the CSI decompression model include a channel decoder, the channel decoder may include a plurality of sub-decoders, and different sub-decoders correspond to different CSI compression parameters; and the second target compression model includes a channel encoder, the channel encoder includes a plurality of sub-encoders, and different sub-encoders correspond to different CSI compression parameters.

In some examples, a model structure of the above second target compression model may be the same as that of the CSI compression model as shown in FIG. 4, for example, the second target compression model may include a channel encoder and a feature converter, the structure of the feature converter may be as shown in FIG. 5, and the structure of the channel encoder may be as shown in FIG. 6. A model structure of the above second target decompression model may be the same as that of the CSI decompression model as shown in FIG. 7, and the above model structures are not repeated here.

In some examples, a second model training step may be recurrently performed until it is determined according to the second sample channel matrix and a second prediction channel matrix that a trained second target network model meets a second preset iteration stopping condition, and the second target decompression model in the trained second target network model is used as the CSI decompression model; and the second prediction channel matrix is a matrix output after the second sample channel matrix is input into the second target network model.

The second model training step may include:
S91, the second sample channel matrix is input into the second target compression model, and a second target sample channel matrix is obtained after the second sample channel matrix is compressed through the plurality of sub-encoders;
S92, the second target sample channel matrix is input into the second target decompression model, and the second prediction channel matrix is obtained after the second target sample channel matrix is decompressed through the plurality of sub-decoders; and
S93, in a case that it is determined according to the second sample channel matrix and the second prediction channel matrix that the second target network model does not meet the second preset iteration stopping condition, a second loss value is determined according to the second sample channel matrix and the second prediction channel matrix, the trained second target network model is obtained by updating parameters of the second target network model according to the second loss value, and the trained second target network model is used as a new second target network model.

It is to be noted that, the above second preset iteration stopping condition may also be determined according to a loss function used in the training process.

In some examples, encoding switches corresponding to all the sub-encoders may be turned on, decoding switches corresponding to all the sub-decoders are also turned on, training errors under a plurality of CSI compression parameters may be jointly optimized, and the loss function used in the training process may also include above formula (5), which is not repeated here.

In this way, by means of joint optimization of the training errors corresponding to the plurality of CSI compression parameters (e.g., preset CSI compression rates), a network may optimize the training errors corresponding to all the preset CSI compression rates during one training, and thus the adaptive capacity of the network for the dynamic change of the CSI compression rates is improved. After training is finished, parameters of the CSI decompression model may be obtained.

In some examples, by means of the above training process, parameters resulted after training of the second target compression model may further be obtained by the network device, and the parameters resulted after training of the second target compression model may be used as parameters of the CSI compression model at the terminal device side.

In some examples, the network device may obtain a second compression model parameter corresponding to the second target compression model in the trained second target network model; and the second compression model parameter is sent to the terminal device so as to instruct the terminal device to determine the CSI compression model according to the second compression model parameter. The CSI compression model is used for the terminal device to obtain a target channel matrix according to a first channel matrix.

For example, the network device may send the second compression model parameter to the terminal device through signaling or a data message.

In other examples of the disclosure, the above training method may be performed on the terminal device, and the network device may receive a first decompression model parameter sent by the terminal device; and the CSI decompression model is determined according to the first decompression model parameter.

For example, the network device may receive the first decompression model parameter sent by the terminal device through signaling or a data message, and determine the parameters corresponding to the CSI decompression model according to the first decompression model parameter.

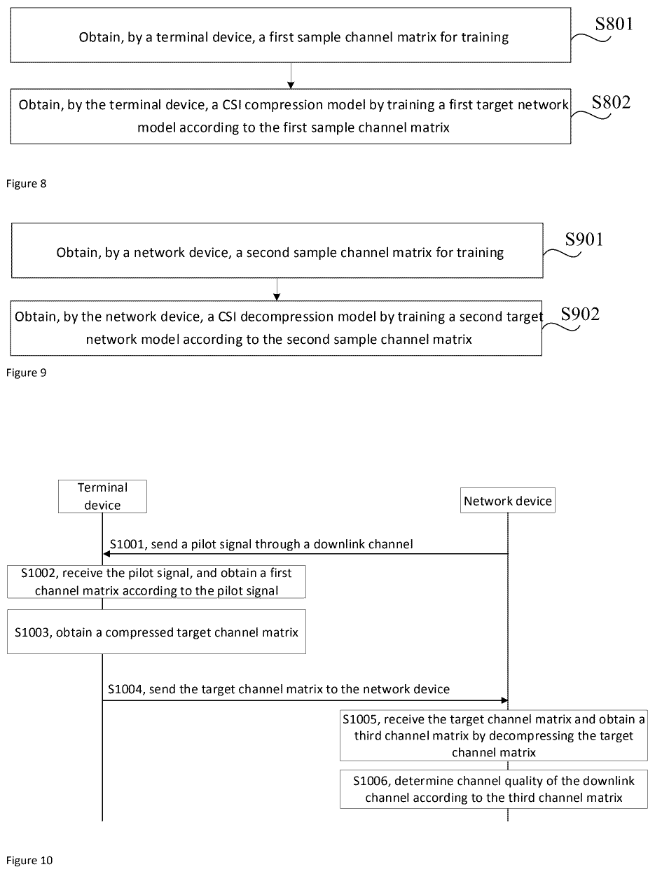

FIG. 10 is a method for acquiring channel quality shown according to an example. As shown in FIG. 10, the method may include steps from S1001 to S1006.
S1001, a pilot signal is sent by a network device through a downlink channel.
S1002, the pilot signal is received by a terminal device through the downlink channel, and a first channel matrix is obtained according to the pilot signal.

The first channel matrix is used to represent the channel quality of the downlink channel.
S1003, a compressed target channel matrix is obtained by compressing the first channel matrix by the terminal device according to a channel state information (CSI) compression model and a CSI compression parameter.

In some examples, the CSI compression model includes a channel encoder, and the channel encoder includes a plurality of sub-encoders; and different sub-encoders correspond to different CSI compression parameters.

In some examples, the CSI compression model may include the channel encoder and a feature converter.
S1004, the target channel matrix is sent to the network device by the terminal device.
S1005, the target channel matrix sent by the terminal device is received by the network device, and a third channel matrix is obtained by decompressing the target channel matrix according to a CSI decompression model and the CSI compression parameter.

The CSI decompression model includes a channel decoder, the channel decoder includes a plurality of sub-decoders, and different sub-decoders correspond to different CSI compression parameters.
S1006, the channel quality of the downlink channel is determined by the network device according to the third channel matrix.

It is to be noted that, the above CSI compression model and the above CSI decompression model may be of any one model structure provided in the above examples, which is not repeated here.

In this way, different CSI compression parameters may be fitted through the plurality of sub-encoders and the plurality of sub-decoders, and thus the relatively accurate target channel matrix may be adaptively obtained by the terminal device and sent to the network device under a scenario where a CSI compression rate changes, such that the relatively accurate channel quality is obtained by the network device, and then the efficiency of data transmission is improved.

FIG. 11 is a block diagram of an apparatus 1100 for acquiring channel quality shown according to an example. The apparatus may be performed by a terminal device. As shown in FIG. 11, the apparatus 1100 may include a first receiving module 1101, a first matrix obtaining module 1102, a target matrix obtaining module 1103, and a first sending module 1104.

The first receiving module 1101, configured to receive a pilot signal sent by a network device through a downlink channel;
the first matrix obtaining module 1102, configured to obtain a first channel matrix according to the pilot signal, where the first channel matrix is used to represent channel quality of the downlink channel;
the target matrix obtaining module 1103, configured to obtain a compressed target channel matrix by compressing the first channel matrix according to a channel state information (CSI) compression model and a CSI compression parameter, where the CSI compression model includes a channel encoder, and the channel encoder includes a plurality of sub-encoders; and different sub-encoders correspond to different CSI compression parameters; and
the first sending module 1104, configured to send the target channel matrix to the network device, such that the channel quality of the downlink channel is determined by the network device according to the target channel matrix.

In some examples, the target matrix obtaining module 1103 is configured to use a sub-encoder corresponding to the CSI compression parameter as a first target sub-encoder, and obtain the target channel matrix by compressing the first channel matrix through the first target sub-encoder.

In some examples, the CSI compression model further includes a feature converter. The target matrix obtaining module 1103 is configured to input the first channel matrix into the feature converter, and obtain a second channel matrix representing a CSI key feature by performing key feature extraction on the first channel matrix; and obtain the target channel matrix by compressing the second channel matrix according to the CSI compression parameter and the channel encoder.

In some examples, the target matrix obtaining module 1103 is configured to use a sub-encoder corresponding to the CSI compression parameter as a second target sub-encoder, and obtain the target channel matrix by compressing the second channel matrix through the second target sub-encoder.

In some examples, the feature converter includes a feature extraction network, an attention mechanism network and a feature restoration network. The target matrix obtaining module 1103 is configured to obtain a plurality of first feature maps by inputting the first channel matrix into the feature extraction network; obtain a second feature map by inputting the plurality of first feature maps into the attention mechanism network, where the second feature map includes key feature information in the first feature maps; and obtain the second channel matrix by inputting the second feature map into the feature restoration network.

In some examples, the target matrix obtaining module 1103 is configured to obtain a max-pooling feature map by performing a max-pooling operation on the plurality of first feature maps through the attention mechanism network; obtain a mean-pooling feature map by performing a mean-pooling operation on the plurality of first feature maps through the attention mechanism network; and determine the second feature map according to the max-pooling feature map and the mean-pooling feature map.

In some examples, the attention mechanism network includes a fusion sub-network. The target matrix obtaining module 1103 is configured to obtain a fused fusion feature map by inputting the max-pooling feature map and the mean-pooling feature map into the fusion sub-network; and obtain the second feature map by calculation according to the fusion feature map and the first feature maps.

In some examples, the first matrix obtaining module 1102 is configured to obtain a space domain channel matrix by measurement according to the pilot signal; transform the space domain channel matrix into an angle delay domain channel matrix through discrete Fourier transform; and determine the first channel matrix according to the angle delay domain channel matrix.

FIG. 12 is a block diagram of an apparatus 1100 for acquiring channel quality shown according to an example. As shown in FIG. 12, the apparatus 1100 may further include a first training module 1105, and the first training module 1105 is configured to train an obtained CSI compression model in the following ways:
a first sample channel matrix for training is obtained, where the first sample channel matrix is a matrix obtained by a terminal device according to a received pilot signal and used to represent the quality of a downlink channel; and
the CSI compression model is obtained by training a first target network model according to the first sample channel matrix, where
the first target network model includes a first target compression model and a first target decompression model, a network structure of the first target compression model is the same as a network structure of the CSI compression model, the first target decompression model includes a channel decoder, the channel decoder includes a plurality of sub-decoders, and different sub-decoders correspond to different CSI compression parameters.

In some examples, the first training module 1105 is configured to recurrently perform a first model training step until it is determined according to the first sample channel matrix and a first prediction channel matrix that a trained first target network model meets a first preset iteration stopping condition, and use the first target compression model in the trained first target network model as the CSI compression model, where the first prediction channel matrix is a matrix output after the first sample channel matrix is input into the first target network model.

The first model training step includes:
the first sample channel matrix is input into the first target compression model, and a first target sample channel matrix is obtained after the first sample channel matrix is compressed through a plurality of sub-encoders;
the first target sample channel matrix is input into the first target decompression model, and the first prediction channel matrix is obtained after the first target sample channel matrix is decompressed through the plurality of sub-decoders; and
in a case that it is determined according to the first sample channel matrix and the first prediction channel matrix that the first target network model does not meet the first preset iteration stopping condition, a first loss value is determined according to the first sample channel matrix and the first prediction channel matrix, the trained first target network model is obtained by updating parameters of the first target network model according to the first loss value, and the trained first target network model is used as a new first target network model.

In some examples, the first sending module 1104 is further configured to obtain a first decompression model parameter corresponding to the first target decompression model in the trained first target network model; and send the first decompression model parameter to a network device, such that the network device is instructed to determine a CSI decompression model according to the first decompression model parameter, where the CSI decompression model is used for the network device to determine the channel quality of the downlink channel according to a target channel matrix.

In some examples, the first receiving module 1101 is further configured to receive a second compression model parameter sent by the network device; and determine the CSI compression model according to the second compression model parameter.

In some examples, the first receiving module 1101 is further configured to receive a first compression parameter sent by the network device; and determine a CSI compression parameter according to the first compression parameter.

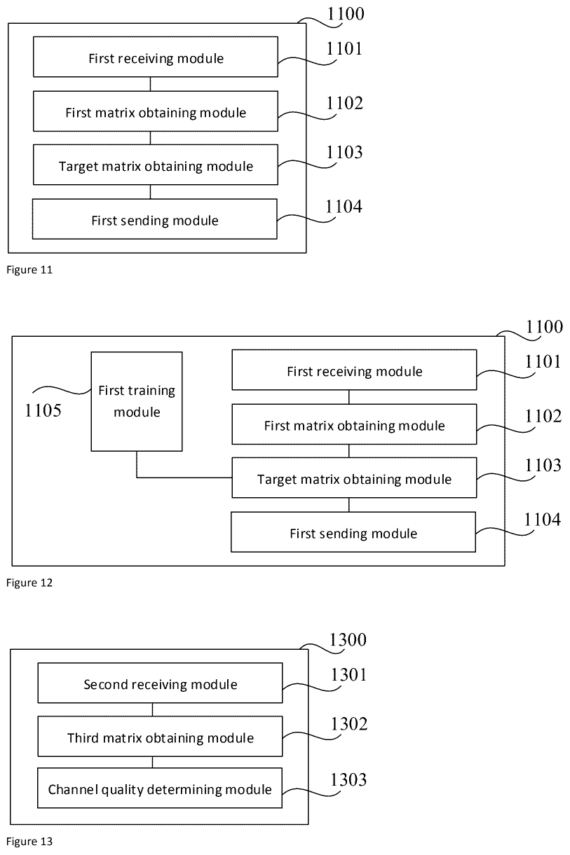

FIG. 13 is a block diagram of an apparatus 1300 for acquiring channel quality shown according to an example. The apparatus may be performed by a network device. As shown in FIG. 13, the apparatus 1300 may include a second receiving module 1301, a third matrix obtaining module 1302, and a channel quality determining module 1303.

The second receiving module 1301, configured to receive a target channel matrix sent by a terminal device, where the target channel matrix is obtained after a first channel matrix is compressed by the terminal device according to a channel state information (CSI) compression model and a CSI compression parameter, and the first channel matrix is a matrix obtained by the terminal device according to a pilot signal and used to represent channel quality of a downlink channel;
the third matrix obtaining module 1302, configured to obtain a third channel matrix by decompressing the target channel matrix according to a CSI decompression model and the CSI compression parameter, where the CSI decompression model includes a channel decoder, the channel decoder includes a plurality of sub-decoders, and different sub-decoders correspond to different CSI compression parameters; and
the channel quality determining module 1303, configured to determine the channel quality of the downlink channel according to the third channel matrix.

In some examples, the third matrix obtaining module 1302 is configured to use a sub-decoder corresponding to the CSI compression parameter as a target sub-decoder; obtain a fourth channel matrix by decompressing the target channel matrix through the target sub-decoder; and determine the third channel matrix according to the fourth channel matrix.

In some examples, the CSI decompression model further includes a CSI reconstruction module. The third matrix obtaining module 1302 is configured to input the fourth channel matrix into the CSI reconstruction module to obtain the third channel matrix.

FIG. 14 is a block diagram of an apparatus 1300 for acquiring channel quality shown according to an example. As shown in FIG. 14, the apparatus 1300 may further include a second training module 1304, and the second training module 1304 is configured to train an obtained CSI decompression model in the following ways:
a second sample channel matrix for training is obtained, where the second sample channel matrix is a matrix obtained by a terminal device according to a received pilot signal and used to represent the quality of a downlink channel; and
a CSI compression model is obtained by training a second target network model according to the second sample channel matrix, where
the second target network model includes a second target compression model and a second target decompression model, a network structure of the second target decompression model is the same as a network structure of the CSI decompression model, the second target compression model includes a channel encoder, the channel encoder includes a plurality of sub-encoders, and different sub-encoders correspond to different CSI compression parameters.

In some examples, the second training module 1304 is configured to recurrently perform a second model training step until it is determined according to the second sample channel matrix and a second prediction channel matrix that a trained second target network model meets a second preset iteration stopping condition, and use the second target decompression model in the trained second target network model as the CSI decompression model, where the second prediction channel matrix is a matrix output after the second sample channel matrix is input into the second target network model.

The second model training step includes:
the second sample channel matrix is input into the second target compression model, and a second target sample channel matrix is obtained after the second sample channel matrix is compressed through the plurality of sub-encoders;
the second target sample channel matrix is input into the second target decompression model, and the second prediction channel matrix is obtained after the second target sample channel matrix is decompressed through a plurality of sub-decoders; and
in a case that it is determined according to the second sample channel matrix and the second prediction channel matrix that the second target network model does not meet the second preset iteration stopping condition, a second loss value is determined according to the second sample channel matrix and the second prediction channel matrix, the trained second target network model is obtained by updating parameters of the second target network model according to the second loss value, and the trained second target network model is used as a new second target network model.

FIG. 15 is a block diagram of an apparatus 1300 for acquiring channel quality shown according to an example. As shown in FIG. 15, the apparatus 1300 may further include:
a second sending module 1305, configured to obtain a second compression model parameter corresponding to a second target compression model in a trained second target network model; and send the second compression model parameter to a terminal device, such that the terminal device is instructed to determine a CSI compression model according to the second compression model parameter, where the CSI compression model is used for the terminal device to obtain a target channel matrix according to a first channel matrix.

In some examples, the second receiving module 1301 is further configured to receive a first decompression model parameter sent by the terminal device; and determine a CSI decompression model according to the first decompression model parameter.

In some examples, the second sending module 1305 is configured to determine a first compression parameter according to a CSI compression parameter, and send the first compression parameter to the terminal device.

As for the apparatus in the above example, the specific manner in which each module performs operations has been described in detail in the example of the method, which will not be described in detail here.

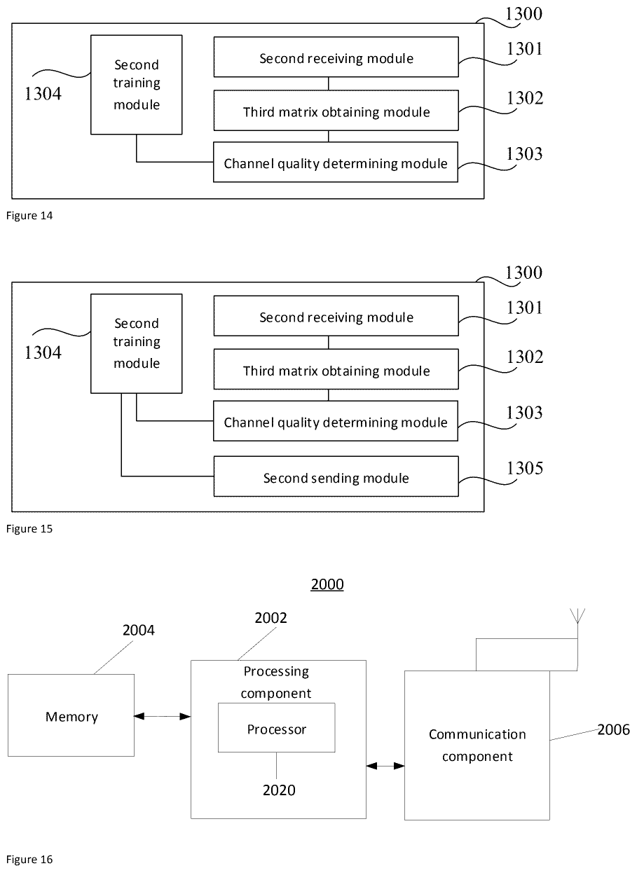

FIG. 16 is a block diagram of an apparatus for acquiring channel quality shown according to an example. The apparatus 2000 for acquiring the channel quality may be the terminal device in the communication system shown in FIG. 1 or the network device in the communication system.

Referring to FIG. 16, the apparatus 2000 may include one or more of the following components: a processing component 2002, a memory 2004, and a communication component 2006.

The processing component 2002 may control the overall operation of the apparatus 2000, such as operations associated with display, telephone call, data communication, camera operations, and recording operations. The processing component 2002 may include one or more processors 2020 to execute instructions so as to complete all or part of the steps of the above method for acquiring channel quality. In addition, the processing component 2002 may include one or more modules to facilitate interaction between the processing component 2002 and other components. For example, the processing component 2002 may include a multimedia module to facilitate interactions between a multimedia component and the processing component 2002.

The memory 2004 is configured to store various types of data to support operations at the apparatus 2000. Instances of these data include instructions for any application or method operating on the apparatus 2000, contact data, phonebook data, messages, pictures, videos, etc. The memory 2004 may be implemented by any type of volatile or nonvolatile storage device or their combinations, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, and a magnetic disk or optic disk.

The communication component 2006 is configured to facilitate wired or wireless communication between the apparatus 2000 and other devices. The apparatus 2000 may access a wireless network based on a communication standard, such as communication techniques like WiFi, 2G, 3G, 4G, 5G or 6G, or their combinations. In an example, the communication component 2006 receives a broadcast signal or broadcast-related information from an external broadcast management system via a broadcast channel. In an example, the communication component 2006 further includes a near field communication (NFC) module to facilitate short-range communication. For instance, the NFC module may be implemented based on a radio frequency identification (RFID) technology, an infrared data association (IrDA) technology, an ultra wideband (UWB) technology, a Bluetooth (BT) technology and other technologies.

In an example, the apparatus 2000 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements for performing the above method for acquiring channel quality.

The above apparatus 2000 may be an independent electronic device, or part of an independent electronic device. For instance, in an example, the electronic device may be an integrated circuit (IC) or a chip, where the integrated circuit may be an IC or a collection of a plurality of ICs. The chip may include but is not limited to the following types: a graphics processing unit (GPU), a central processing unit (CPU), a field programmable gate array (FPGA), a digital signal processor (DSP), an application specific integrated circuit (ASIC), a system on chip (SoC), etc. The above integrated circuit or chip may be configured to execute executable instructions (or codes), so as to implement the above method for acquiring channel quality. The executable instructions may be stored in the integrated circuit or chip, or obtained from other apparatuses or devices, for instance, the integrated circuit or chip may include a processor, a memory, and an interface for communication with other apparatuses. The executable instructions may be stored in the processor, and the executable instructions, when executed by the processor, implement the above method for acquiring channel quality; or, the integrated circuit or chip may receive the executable instructions through the interface and transmit the executable instructions to the processor for executing so as to implement the above method for acquiring channel quality.

In an example, the disclosure further provides a computer-readable storage medium, storing computer program instructions, and the program instructions, when executed by a processor, implement steps of the method for acquiring channel quality provided by the disclosure. For example, the computer-readable storage medium may be a non-temporary computer-readable storage medium including instructions, such as the above memory 2004 including instructions, which may be executed by the processor 2020 of the apparatus 2000 to complete the above method for acquiring channel quality. For instance, the non-temporary computer-readable storage medium may be a ROM, a random access memory (RAM), a CD-ROM, a magnetic tape, a floppy disk, an optical data storage device, etc.

In another example, a computer program product is further provided. The computer program product contains a computer program executable by a programmable apparatus. The computer program has a code part which is configured to, when executed by the programmable apparatus, execute the above method for acquiring channel quality.

To solve the above problems existing in the related art, the disclosure provides a method and apparatus for acquiring channel quality, a storage medium and a chip.

According to a first aspect of an example of the disclosure, a method for acquiring channel quality is provided, and the method is performed by a terminal device and includes:
receiving a pilot signal sent by a network device through a downlink channel;
obtaining a first channel matrix according to the pilot signal, where the first channel matrix is used to represent channel quality of the downlink channel;
obtaining a compressed target channel matrix by compressing the first channel matrix according to a channel state information (CSI) compression model and a CSI compression parameter, where the CSI compression model includes a channel encoder, and the channel encoder includes a plurality of sub-encoders; and different sub-encoders correspond to different CSI compression parameters; and
sending the target channel matrix to the network device, such that the channel quality of the downlink channel is acquired by the network device according to the target channel matrix.

According to a second aspect of an example of the disclosure, a method for acquiring channel quality is provided, and the method is performed by a network device and includes:
receiving a target channel matrix sent by a terminal device, where the target channel matrix is obtained after a first channel matrix is compressed by the terminal device according to a channel state information (CSI) compression model and a CSI compression parameter, and the first channel matrix is a matrix obtained by the terminal device according to a pilot signal and used to represent channel quality of a downlink channel;
obtaining a third channel matrix by decompressing the target channel matrix according to a channel state information (CSI) decompression model and the CSI compression parameter, where the CSI decompression model includes a channel decoder, the channel decoder includes a plurality of sub-decoders, and different sub-decoders correspond to different CSI compression parameters; and
determining the channel quality of the downlink channel according to the third channel matrix.

According to a third aspect of an example of the disclosure, an apparatus for acquiring channel quality is provided, and the apparatus is performed by a terminal device and includes:
a first receiving module, configured to receive a pilot signal sent by a network device through a downlink channel;
a first matrix obtaining module, configured to obtain a first channel matrix according to the pilot signal, where the first channel matrix is used to represent channel quality of the downlink channel;
a target matrix obtaining module, configured to obtain a compressed target channel matrix by compressing the first channel matrix according to a channel state information (CSI) compression model and a CSI compression parameter, where the CSI compression model includes a channel encoder, and the channel encoder includes a plurality of sub-encoders; and different sub-encoders correspond to different CSI compression parameters; and
a first sending module, configured to send the target channel matrix to the network device, such that the channel quality of the downlink channel is acquired by the network device according to the target channel matrix.

According to a fourth aspect of an example of the disclosure, an apparatus for acquiring channel quality is provided, and the apparatus is performed by a network device and includes:
a second receiving module, configured to receive a target channel matrix sent by a terminal device, where the target channel matrix is obtained after a first channel matrix is compressed by the terminal device according to a channel state information (CSI) compression model and a CSI compression parameter, and the first channel matrix is a matrix obtained by the terminal device according to a pilot signal and used to represent channel quality of a downlink channel;
a third matrix obtaining module, configured to obtain a third channel matrix by decompressing the target channel matrix according to a channel state information (CSI) decompression model and the CSI compression parameter, where the CSI decompression model includes a channel decoder, the channel decoder includes a plurality of sub-decoders, and different sub-decoders correspond to different CSI compression parameters; and
a channel quality determining module, configured to determine the channel quality of the downlink channel according to the third channel matrix.

According to a fifth aspect of an example of the disclosure, an apparatus for acquiring channel quality is provided, including:
one or more processors; and
a memory, configured to store processor-executable instructions; where
the processor is configured to execute steps of the method for acquiring channel quality provided in the first aspect of the disclosure.

According to a sixth aspect of an example of the disclosure, an apparatus for acquiring channel quality is provided, including:
one or more processors; and
a memory, configured to store processor-executable instructions; where
the processor is configured to execute steps of the method for acquiring channel quality provided in the second aspect of the disclosure.

According to a seventh aspect of an example of the disclosure, a computer-readable storage medium is provided, storing computer program instructions, and the computer program instructions, when executed by one or more processors, implement steps of the method for acquiring channel quality provided in the first aspect of the disclosure.

According to an eighth aspect of an example of the disclosure, a computer-readable storage medium is provided, storing computer program instructions, and the computer program instructions, when executed by one or more processors, implement steps of the method for acquiring channel quality provided in the second aspect of the disclosure.

According to a ninth aspect of an example of the disclosure, a chip is provided, including: one or more processors and an interface. The processor is configured to read instructions to execute steps of the method for acquiring channel quality provided in the first aspect of the disclosure.

According to a tenth aspect of an example of the disclosure, a chip is provided, including: one or more processors and an interface. The processor is configured to read instructions to execute steps of the method for acquiring channel quality provided in the second aspect of the disclosure.

The technical solution provided by the example of the disclosure may include the following beneficial effects: the pilot signal sent by the network device through the downlink channel is received by the terminal device; the first channel matrix is obtained according to the pilot signal; the compressed target channel matrix is obtained by compressing the first channel matrix according to the CSI compression model and the CSI compression parameter; and the target channel matrix is sent to the network device, such that the channel quality of the downlink channel is determined by the network device according to the target channel matrix. The first channel matrix is used to represent the channel quality of the downlink channel. The CSI compression model may include the channel encoder, and the channel encoder includes the plurality of sub-encoders; and different sub-encoders correspond to different CSI compression parameters. The target channel matrix is used to instruct the network device to determine the channel quality of the downlink channel. In this way, different CSI compression parameters may be fitted through the plurality of sub-encoders, and thus a relatively accurate target channel matrix may be adaptively obtained and sent to the network device under a scenario where a CSI compression rate changes, such that the relatively accurate channel quality is obtained by the network device, and then the efficiency of data transmission is improved.

Other implementation solutions of the disclosure will be apparent to those skilled in the art from consideration of the specification and practice of the disclosure. The disclosure is intended to cover any variations, uses, or adaptations of the disclosure following the general principles of the disclosure and including such departures from the disclosure as come within known or customary practice in the art. It is intended that the specification and examples be considered as exemplary merely, with a true scope and spirit of the disclosure being indicated by the following claims.

It will be appreciated that the disclosure is not limited to the exact construction that has been described above and illustrated in the accompanying drawings, and that various modifications and changes may be made without departing from the scope of the disclosure. It is intended that the scope of the disclosure is merely limited by the appended claims.

1. A method for acquiring channel quality, performed by a terminal device, comprising:
receiving a pilot signal sent by a network device through a downlink channel;
obtaining a first channel matrix according to the pilot signal, wherein the first channel matrix is used to represent channel quality of the downlink channel;
obtaining a compressed target channel matrix by compressing the first channel matrix according to a channel state information (CSI) compression model and a CSI compression parameter, wherein the CSI compression model comprises a channel encoder, and the channel encoder comprises a plurality of sub-encoders; and different sub-encoders correspond to different CSI compression parameters; and
sending the compressed target channel matrix to the network device, such that the channel quality of the downlink channel is determined by the network device according to the compressed target channel matrix.

2. The method according to claim 1, wherein obtaining the compressed target channel matrix by compressing the first channel matrix according to the CSI compression model and the CSI compression parameter comprises:
using a sub-encoder corresponding to the CSI compression parameter as a first target sub-encoder; and
obtaining the compressed target channel matrix by compressing the first channel matrix through the first target sub-encoder.

3. The method according to claim 1, wherein the CSI compression model further comprises a feature converter; and the obtaining the compressed target channel matrix by compressing the first channel matrix according to the CSI compression model and the CSI compression parameter comprises:
inputting the first channel matrix into the feature converter, and obtaining a second channel matrix representing a CSI key feature by performing key feature extraction on the first channel matrix; and
obtaining the compressed target channel matrix by compressing the second channel matrix according to the CSI compression parameter and the channel encoder.

4. The method according to claim 3, wherein obtaining the compressed target channel matrix by compressing the second channel matrix according to the CSI compression parameter and the channel encoder comprises:
using a sub-encoder corresponding to the CSI compression parameter as a second target sub-encoder; and
obtaining the compressed target channel matrix by compressing the second channel matrix through the second target sub-encoder.

5. The method according to claim 3, wherein the feature converter comprises a feature extraction network, an attention mechanism network and a feature restoration network; and inputting the first channel matrix into the feature converter, and the obtaining a second channel matrix representing a CSI key feature by performing key feature extraction on the first channel matrix comprises:
obtaining a plurality of first feature maps by inputting the first channel matrix into the feature extraction network;
obtaining a second feature map by inputting the plurality of first feature maps into the attention mechanism network, wherein the second feature map comprises key feature information in the plurality of first feature maps; and
obtaining the second channel matrix by inputting the second feature map into the feature restoration network.

6. The method according to claim 5, wherein obtaining the second feature map by inputting the plurality of first feature maps into the attention mechanism network comprises:
obtaining a max-pooling feature map by performing a max-pooling operation on the plurality of first feature maps through the attention mechanism network;
obtaining a mean-pooling feature map by performing a mean-pooling operation on the plurality of first feature maps through the attention mechanism network; and
determining the second feature map according to the max-pooling feature map and the mean-pooling feature map;
wherein the attention mechanism network comprises a fusion sub-network; and determining the second feature map according to the max-pooling feature map and the mean-pooling feature map comprises:
obtaining a fused fusion feature map by inputting the max-pooling feature map and the mean-pooling feature map into the fusion sub-network; and
determining the second feature map according to the fused fusion feature map and the plurality of first feature maps.

7. (canceled)

8. The method according to claim 1, wherein obtaining the first channel matrix according to the pilot signal comprises:
obtaining a space domain channel matrix by measurement according to the pilot signal;
transforming the space domain channel matrix into an angle delay domain channel matrix through discrete Fourier transform; and
determining the first channel matrix according to the angle delay domain channel matrix.

9. The method according to claim 1, wherein the CSI compression model is obtained by:
obtaining a first sample channel matrix for training, wherein the first sample channel matrix is a matrix obtained by the terminal device according to a received pilot signal and used to represent a quality of the downlink channel; and
obtaining the CSI compression model by training a first target network model according to the first sample channel matrix, wherein
the first target network model comprises a first target compression model and a first target decompression model, a network structure of the first target compression model is the same as a network structure of the CSI compression model, the first target decompression model comprises a channel decoder, the channel decoder comprises a plurality of sub-decoders, and different sub-decoders correspond to different CSI compression parameters.

10. The method according to claim 9, wherein training the first target network model according to the first sample channel matrix comprises:
recurrently performing a first model training step until it is determined according to the first sample channel matrix and a first prediction channel matrix that a trained first target network model meets a first preset iteration stopping condition, and using the first target compression model in the trained first target network model as the CSI compression model, wherein the first prediction channel matrix is a matrix output after the first sample channel matrix is input into the first target network model; and
the first model training step comprises:
inputting the first sample channel matrix into the first target compression model, and obtaining a first target sample channel matrix after the first sample channel matrix is compressed through the plurality of sub-encoders;
inputting the first target sample channel matrix into the first target decompression model, and obtaining the first prediction channel matrix after the first target sample channel matrix is decompressed through the plurality of sub-decoders; and
in a case that it is determined according to the first sample channel matrix and the first prediction channel matrix that the first target network model does not meet the first preset iteration stopping condition, determining a first loss value according to the first sample channel matrix and the first prediction channel matrix, obtaining the trained first target network model by updating parameters of the first target network model according to the first loss value, and using the trained first target network model as a new first target network model.

11. The method according to claim 9, further comprising:
obtaining a first decompression model parameter corresponding to the first target decompression model in the trained first target network model; and
sending the first decompression model parameter to the network device, such that the network device is instructed to determine a CSI decompression model according to the first decompression model parameter, wherein the CSI decompression model is used for the network device to determine the channel quality of the downlink channel according to the target channel matrix.

12. The method according to 1, further comprising:
receiving a second compression model parameter sent by the network device; and determining the CSI compression model according to the second compression model parameter; and/or
receiving a first compression parameter sent by the network device; and determining the CSI compression parameter according to the first compression parameter.

13. (canceled)

14. A method for acquiring channel quality, performed by a network device, comprising:
receiving a target channel matrix sent by a terminal device, wherein the target channel matrix is obtained after a first channel matrix is compressed by the terminal device according to a channel state information (CSI) compression model and a CSI compression parameter, and the first channel matrix is a matrix obtained by the terminal device according to a pilot signal and used to represent channel quality of a downlink channel;
obtaining a third channel matrix by decompressing the target channel matrix according to a CSI decompression model and the CSI compression parameter, wherein the CSI decompression model comprises a channel decoder, the channel decoder comprises a plurality of sub-decoders, and different sub-decoders correspond to different CSI compression parameters; and
determining the channel quality of the downlink channel according to the third channel matrix.

15. The method according to claim 14, wherein the obtaining a third channel matrix by decompressing the target channel matrix according to the CSI decompression model and the CSI compression parameter comprises:
using a sub-decoder corresponding to the CSI compression parameter as a target sub-decoder;
obtaining a fourth channel matrix by decompressing the target channel matrix through the target sub-decoder; and
determining the third channel matrix according to the fourth channel matrix.

16. The method according to claim 15, wherein the CSI decompression model further comprises a CSI reconstruction module; and determining the third channel matrix according to the fourth channel matrix comprises:
obtaining the third channel matrix by inputting the fourth channel matrix into the CSI reconstruction module.

17. The method according to claim 14, wherein the CSI decompression model is obtained by:
obtaining a second sample channel matrix for training, wherein the second sample channel matrix is a matrix obtained by the terminal device according to a received pilot signal and used to represent the quality of the downlink channel; and
obtaining the CSI decompression model by training a second target network model according to the second sample channel matrix, wherein
the second target network model comprises a second target compression model and a second target decompression model, a network structure of the second target decompression model is the same as a network structure of the CSI decompression model, the second target compression model comprises a channel encoder, the channel encoder comprises a plurality of sub-encoders, and different sub-encoders correspond to different CSI compression parameters.

18. The method according to claim 17, wherein training the second target network model according to the second sample channel matrix comprises:
recurrently performing a second model training step until it is determined according to the second sample channel matrix and a second prediction channel matrix that a trained second target network model meets a second preset iteration stopping condition, and using the second target decompression model in the trained second target network model as the CSI decompression model, wherein the second prediction channel matrix is a matrix output after the second sample channel matrix is input into the second target network model; and
the second model training step comprises:
inputting the second sample channel matrix into the second target compression model, and obtaining a second target sample channel matrix after the second sample channel matrix is compressed through the plurality of sub-encoders;
inputting the second target sample channel matrix into the second target decompression model, and obtaining the second prediction channel matrix after the second target sample channel matrix is decompressed through the plurality of sub-decoders; and
in a case that it is determined according to the second sample channel matrix and the second prediction channel matrix that the second target network model does not meet the second preset iteration stopping condition, determining a second loss value according to the second sample channel matrix and the second prediction channel matrix, obtaining the trained second target network model by updating parameters of the second target network model according to the second loss value, and using the trained second target network model as a new second target network model.

19. The method according to claim 17, further comprising:
obtaining a second compression model parameter corresponding to the second target compression model in the trained second target network model; and
sending the second compression model parameter to the terminal device, such that the terminal device is instructed to determine a CSI compression model according to the second compression model parameter, wherein the CSI compression model is used for the terminal device to obtain the target channel matrix according to the first channel matrix.

20. The method according to claim 14, further comprising:
receiving a first decompression model parameter sent by the terminal device; and determining the CSI decompression model according to the first decompression model parameter; and/or
determining a first compression parameter according to the CSI compression parameter; and
sending the first compression parameter to the terminal device.

21-23. (canceled)

24. An apparatus for acquiring channel quality, comprising:
one or more processors; and
a memory for storing instructions executable by the one or more processors; wherein
the executable instructions, when executed by the one or more processors, cause the apparatus to:
receive a pilot signal sent by a network device through a downlink channel;
obtain a first channel matrix according to the pilot signal, wherein the first channel matrix is used to represent channel quality of the downlink channel;
obtain a compressed target channel matrix by compressing the first channel matrix according to a channel state information (CSI) compression model and a CSI compression parameter, wherein the CSI compression model comprises a channel encoder, and the channel encoder comprises a plurality of sub-encoders, and different sub-encoders correspond to different CSI compression parameters; and
send the compressed target channel matrix to the network device, such that the channel quality of the downlink channel is determined by the network device according to the compressed target channel matrix.

25-26. (canceled)

27. An apparatus for acquiring channel quality, comprising:
one or more processors; and
a memory for storing instructions executable by the one or more processors;
wherein the executable instructions, when executed by the one or more processors, cause the apparatus to perform the method of claim 14.
